(19) United States
(12) Patent Application Publication
(10) Pub. No.: US 2007/0290019 A1
(43) Pub. Date: Dec. 20, 2007

(54) Hand-held setting device

(76) Inventors: Dierk Tille, Feldkirch (AT); Stefan Boenig, Achberg-Esseratsweiler (DE); Kurt Oehri, Schaan (LI)

Correspondence Address: ABELMAN, FRAYNE & SCHWAB, 666 THIRD AVENUE, 10TH FLOOR, NEW YORK, NY, 10017, US

(21) Appl. No.: 11/807,676

(22) Filed: May 29, 2007

(30) Foreign Application Priority Data
May 30, 2006 (DE) 10 2006 000 254.7

(51) Int. Cl. B25C 1/14

(52) U.S. Cl. 227/10

(57) ABSTRACT

The present invention is directed to a setting device with a muzzle part for fasteners (51) in which a fastener guide (15) is arranged so as to be displaceable axially, with a receiving space (23) for a fastener (51), which receiving space (23) is partially encircled by guide surfaces, and with a detector element (31) for a fastener in the receiving space, wherein a first guide surface (34) of the guide surfaces for a fastener is arranged at the side of the detector element (3) facing the receiving space (23). The first guide surface (34) extends parallel to a longitudinal direction of the muzzle part. To improve a setting device of this kind, concave second and third guide surfaces (35, 36) are arranged at the side of the detector element (31) facing the receiving space (23) so as to adjoin the first guide surface on opposite sides in longitudinal direction.

### BACKGROUND OF THE INVENTION

1. Field of the Invention

The present invention is directed to a hand-held setting device with a muzzle part, and more specifically to setting devices having a muzzle part that can be operated, for example, with solid, gaseous or liquid combustibles, with compressed air, or electrically. In combustion-operated setting devices, a setting piston is driven by means of the high-pressure combustion gases. Fasteners can then be driven into a substrate by means of this setting piston.

2. Description of the Prior Art

US 2005/0017046 discloses a setting device for driving in fasteners having a fastener guide that is guided so as to be displaceable in a muzzle part of the setting device and having a magazine for fasteners which projects laterally from the muzzle part. A receiving space for a fastener that is to be driven into a substrate is arranged in the muzzle part and opens toward a guide channel for fasteners of the magazine. The receiving space has guide surfaces by means of which a fastener located in the receiving space is guided and aligned. Further, a detector for detecting fasteners is arranged at the muzzle part and can detect the presence of a fastener in the receiving space of the muzzle part. The guide surfaces are formed in the fastener guide and also at the detector. The detector engages in the fastener guide through an axially extending slot and has a guide surface which is elongated in axial direction and narrow transverse to this axial direction. When there is no fastener present in the receiving space, the detector is moved into a safety position in which a displacement of the fastener guide in the muzzle part is prevented. A setting process is impossible in this safety position.

However, it is disadvantageous that owing to the arrangement of a portion of the guide surfaces at the axially displaceable fastener guide, fasteners may not be optimally positioned in the receiving space when the fastener guide is displaced, particularly when there are only a few fasteners in the guide channel of the magazine.

### SUMMARY OF THE INVENTION

Therefore, it is the object of the present invention to develop a setting device of the type mentioned above having a muzzle part in which the aforementioned disadvantages are avoided and which ensures an optimal positioning and guidance of the fasteners in the receiving space.

According to the invention, this object is met by a setting device having the features of the independent claim. Accordingly, concave second and third guide surfaces which extend parallel to the longitudinal direction of the muzzle part are arranged at the side of the detector element facing the receiving space so as to adjoin the first guide surface on opposite sides in longitudinal direction and respectively adjoin the first guide surface laterally. Owing to this construction of the guide surfaces for guiding and positioning the fasteners, or the carrier segments of the fastener strip receiving the fasteners, at the detector element which is static with respect to the displaceable fastener guide, a sufficient frictional engagement with the carrier segment of the fasteners is achieved and tilting or tipping of a fastener located in the receiving space is reliably prevented during the contact pressing process, particularly when there are only a few fasteners remaining in the magazine.

In an advantageous further development of the invention, the detector element has at its side facing the receiving space, a detection portion which is formed as a half-cup-shaped tubular segment at which the guide surfaces are arranged. In this way, sufficient area for the guide surfaces can be provided in a simple manner without substantially increasing the space requirement.

Further, it is advantageous when the first, second and third guide surfaces together encircle the receiving space in radial direction by 120° to 180° so that it is not necessary to provide additional guide surfaces at the base body of the muzzle part or at the fastener guide. The first, second and third guide surfaces together preferably encircle the receiving space in radial direction by at least 140° to 160°. In this way, an optimal guiding of the carrier segment is achieved on the one hand and a trouble-free swiveling behavior of the detector element is achieved on the other hand.

The detector element is advantageously mounted at a bearing so as to be swivelable parallel to the longitudinal direction of the muzzle part at the base body of the muzzle part so that an optimal functioning of the fastener detector is ensured, since friction is reduced compared to a displaceable element. Further, the capability of swiveling in longitudinal direction of the muzzle part economizes on installation space because the detector element would otherwise have to be arranged entirely above or across from the magazine.

### BRIEF DESCRIPTION OF THE DRAWINGS

FIG. 1 is a partial cross-sectional view of the setting device with a muzzle part according to the present invention when not pressed against a substrate;

FIG. 2 is a cross-sectional view of the setting device of FIG. 1 with a magazine when pressed against a substrate;

FIG. 3 is a front perspective view of the muzzle part of the setting device along arrow III of FIG. 1; and

FIG. 4 is a front perspective view of the muzzle part of the setting device of FIG. 3 with an empty receiving space.

To facilitate understanding of the invention, identical reference numerals have been used, when appropriate, to designate the same or similar elements that are common to the figures. Further, unless stated otherwise, the drawings shown and discussed in the figures are not drawn to scale, but are shown for illustrative purposes only.

### DETAILED DESCRIPTION OF THE PREFERRED EMBODIMENTS

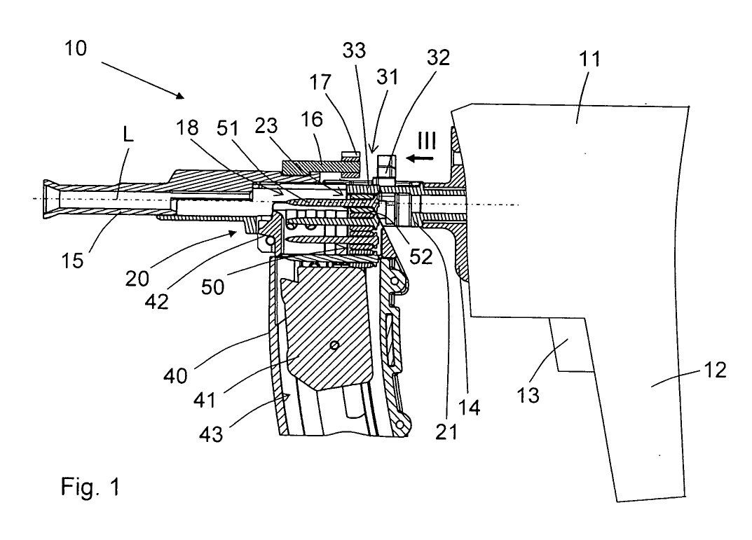

FIGS. 1 to 4 show a combustion-operated, hand-held setting device 10. The setting device 10 has a setting mechanism, not shown, which is arranged in a housing 11 comprising one or more parts and which has a setting piston that is displaceably guided in a piston guide 14 for driving fasteners 51 into a construction element K. A trigger switch 13 is arranged at a handle 12 of the setting device 10 for triggering a setting process.

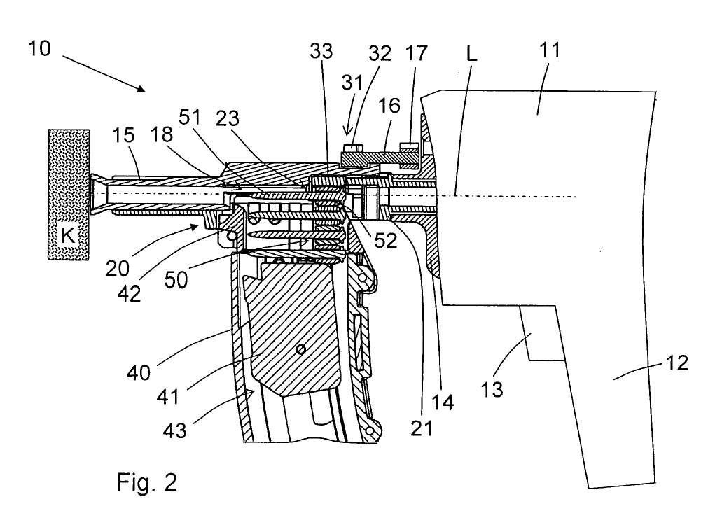

A muzzle part, designated in its entirety by 20, is arranged at the setting device 10 in front of the housing 11 and adjoins the guide cylinder 14 at one side (see particularly FIGS. 1 and 2). A fastener guide 15 is guided at the muzzle part 20 so as to be displaceable relative to a base body 21 of the muzzle part 20. The fastener guide 15 is supported at the base body 21 by a spring element, not shown in the drawings, or at another structural component part which is fixed with respect to the housing by which the fastener guide 15 is acted upon resiliently in direction of the position, shown in FIG. 1, in which it is not pressed against a substrate.

Referring to FIG. 2, when the setting device 12 is pressed against a construction element K, the fastener guide 15 is displaced in direction of the guide cylinder 14 and the spring element is tensioned. A contact pressing element 16, which is fixedly connected to the fastener guide 15, is moved along with the fastener guide 15 so that the setting device 10 is moved into a ready state in which a setting process can be initiated by the trigger switch 13. Valve means, for example, for the combustion chamber are actuated by the contact pressure gauge 16 and by actuating elements which are arranged downstream of the latter and are not shown in the drawings.

A receiving space 23 extending in longitudinal direction L of the fastener guide 15 is arranged in the muzzle part 20. Only a fastener 51 that is properly positioned in the receiving space 23 can be engaged by the setting piston and driven into a construction element K. The fasteners 51 are supplied to the receiving space 23 by a magazine 40 which is arranged at the muzzle part 20 preferably so as to be removable. The magazine is secured to the base body 21 of the muzzle part 20 by a connection portion 42. A guide space 43 in which the fasteners 51 are guided is formed in the magazine 40. The fasteners 51 are assembled, for example, to form a fastener strip 50, which can be introduced into the guide space 43 and in which a plurality of fasteners 51 are arranged at a carrier element comprising a plurality of carrier segments 52.

A transporting element 41 is arranged in the magazine 40 (see FIGS. 1, 2 and 4) and is acted upon in its working position toward the receiving space 23 by a spring element, not shown, in order to ensure transport of fasteners into the receiving space 23.

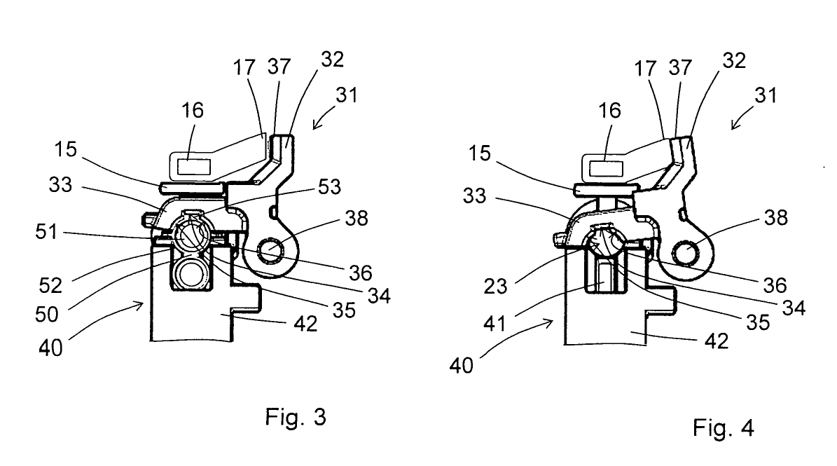

Further, a detector element 31 for detecting a fastener 51 in the receiving space 23 is arranged at the muzzle part 20. This detector element 31 ensures that a setting process can be initiated only when a fastener 51 is located in the receiving space 23 and the setting device 10 is pressed against a construction element K. For this purpose, the detector element 31 is arranged at the side of the receiving space 23 opposite to the magazine 40. The detector element 31 delimits the receiving space 23 at least partially. The detector element 31 is constructed as a lever which is supported at a bearing 38 at the base body 21 of the muzzle part 21 so as to be swivelable parallel to the longitudinal direction L (see particularly FIGS. 3 and 4).

A first arm of the detector element 31 is constructed as a detection portion 33 for fasteners 51, while a second arm forms a projection 32 with a counter-stop 37 for a stop 17 arranged at the contact pressing element 16. At its side facing the receiving space 23, the detection portion 33 is formed as a half-cup-shaped tubular segment having two concave guide surfaces 35, 36 which extend parallel to the longitudinal direction L and which are laterally adjacent to a first guide surface 34 which is recessed in a groove-shaped manner and extends parallel to longitudinal direction L. The inner contour of the detection portion, with its first guide surface 34 and its two concave second and third guide surfaces 35, 36, is optimally adapted to the outer contour of the carrier segments 52 of the fastener strip 50 to ensure a good guidance and positioning of the latter. Web-shaped portions 53 of the carrier segments 52 are guided at the first guide surface 34 which is recessed in a groove-shaped manner. The first, second and third guide surfaces 34, 35, 36 together encircle the receiving space 23 in radial direction by about 120°-180°, preferably by about 140° to 160°.

The detection element 31 is acted upon by a spring element, not shown in the drawings, in direction of its blocking position in which the detection element 31 narrows the guide space 18 in the base body 21 when no fastener 51 is present therein. In this position (see FIG. 4), the detection element 31 blocks a relative movement between the fastener guide 15 and the base body 21 in that the stop 17 of the contact pressing element 16 lies across from the counter-stop 37 at the detector element 31 in this position and comes into contact with it when contact pressing is attempted. Accordingly, contact pressing and a subsequent setting process are prevented in this blocking position of the detector element 31.

In FIG. 1, the setting device 10 is not yet pressed against a construction element by its muzzle part 20. Some fasteners 51 of a fastener strip 50 are located in the guide channel 43 of the magazine 40 and, in particular, a fastener 51 is located in the receiving space 23. The detector element 31 is pressed into its releasing position (see also FIG. 3) by the fastener 51 because the spring force acting on the transporting element 41 in direction of the receiving space 23 is greater than the force of the spring element acting upon the detector element 31. In this releasing position of the detector element 31, it is possible to press the setting device 10 against a construction element K and to carry out a setting process as can be seen from FIG. 2. During the process of pressing against the construction element K, the fastener guide 15 is displaced in direction of the housing 11 and relative to the base body 21. A tilting or tipping of this fastener 51 is safely prevented during the contact pressing process in that the fastener 51 located in the receiving space 23 is guided and enclosed in a positive engagement by means of its carrier segment 52 at the guide surfaces 34, 35, 36 of the detection portion 33 of the detector element 31. The setting device 10 is accordingly ready for initiating a setting process.

Though the present invention was shown and described with references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. A hand-held setting device with a muzzle part (20) for fasteners (51) in which a fastener guide (15) is arranged so as to be displaceable axially, with a receiving space (23) for a fastener (51), the receiving space (23) being partially encircled by guide surfaces, said muzzle part (20) comprising:
a detector element (31) for a fastener (51) positioned in the receiving space (23), a first guide surface (34) of the guide surfaces for the fastener (51) being arranged at the side of the detector element (31) facing the receiving space (23), the first guide surface (34) extending parallel to a longitudinal direction (L) of the muzzle part (20); and concave second and third guide surfaces (35, 36) extending parallel to the longitudinal direction (L) and arranged at a side of the detector element (31) facing the receiving space (23) so as to adjoin the first guide surface (34) on opposite sides in longitudinal direction (L).

2. A setting device according to claim 1, wherein the detector element (31) has at its side facing the receiving space (23), a detection portion (33) which is formed as a half-cup-shaped tubular segment at which the guide surfaces (34, 35, 36) are arranged.

3. A setting device according to claim 1, wherein the first, second and third guide surfaces (34, 35, 36) together encircle the receiving space (23) in radial direction by 120° to 180°.

4. A setting device according to claim 1, wherein the first, second and third guide surfaces (34, 35, 36) together encircle the receiving space (23) in radial direction by at least 140° to 160°.

5. A setting device according to claim 1, wherein the detector element (31) is mounted at a bearing (38) so as to be swivelable parallel to the longitudinal direction (L) at the base body (21) of the muzzle part (20).
